(19) United States
(12) Patent Application Publication
(10) Pub. No.: US 2008/0239006 A1
(43) Pub. Date: Oct. 2, 2008

(54) DROPLET EJECTION HEAD, DROPLET EJECTION DEVICE, AND METHOD OF FORMING ELECTRODE SUBSTRATE

(75) Inventors: Yasushi MATSUNO, Matsumoto (JP); Satoshi FUJISAWA, Tatsuno (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/042,534

(22) Filed: Mar. 5, 2008

(30) Foreign Application Priority Data
Mar. 29, 2007 (JP) 2007-086777

(51) Int. Cl. B41J 2/06

(52) U.S. Cl. 347/55; 216/18

(57) ABSTRACT

A droplet ejection head includes: a nozzle substrate provided with a plurality of nozzle holes for ejecting a droplet; a cavity substrate provided with a plurality of ejection cavities each having a diaphragm as a bottom wall functioning as an electrode; and an electrode substrate including: a plurality of individual electrodes each formed in a first groove, opposed to the diaphragm with a gap, and for driving the diaphragm; a driver IC for controlling driving of the plurality of individual electrodes; and input wiring formed in a second grooves, and for inputting one of power and a signal for driving the drover IC from the outside. The second grooves of the electrode substrate are formed deeper than the first grooves, and a thickness of a conductive material of the input wiring is greater than a thickness of the individual electrodes.

### BACKGROUND OF THE INVENTION

1. Technical Field

The present invention relates to a droplet ejection head having nozzles for ejecting droplets forming a multi-nozzle configuration, and a droplet ejection device equipped with the droplet ejection head.

2. Related Art

In recent electrostatic driving inkjet printers, in order for realizing high-speed printing and multi-color printing of high-resolution images, an increase in the number of nozzles and the number of nozzle lines of an inkjet head has been in progress.

Under such circumstances, there has been known an inkjet head having an increased number of nozzle lines in a higher density with a structure having a driver IC, which drives actuators for ejecting ink, built-in inside the inkjet head (see e.g., JP-A-2006-224564).

However, since in such a head having an increased number of nozzles as described above, a plurality of nozzles are driven simultaneously, the time constant of the drive circuit for the actuators increases as the number of nozzles to be driven increases, which makes it easy to cause the delay in the operation of the actuators, namely the delay in the droplet ejection operation. In particular, in the case in which individual electrodes forming the actuators and input wiring for supplying driving signals from the outside to the driver IC are made of indium tin oxide (ITO), the increase in the time constant easily occurs.

### SUMMARY

In consideration of the problem described above, the invention has an advantage of providing a droplet ejection head with an increased number of nozzles driven simultaneously having a delay in the droplet ejection operation reduced as much as possible, and a droplet ejection device equipped with the droplet ejection head.

According to a first aspect of the invention, there is provided a droplet ejection head including a nozzle substrate provided with a plurality of nozzle holes for ejecting a droplet, a cavity substrate provided with a plurality of ejection cavities each having a diaphragm as a bottom wall functioning as an electrode, and an electrode substrate having a plurality of individual electrodes each formed in a first groove, opposed to the diaphragm with a gap, and for driving the diaphragm, a driver IC for controlling driving of the plurality of individual electrodes, and input wiring formed in a second grooves, and for inputting one of power and a signal for driving the driver IC from the outside, wherein the second grooves of the electrode substrate are formed deeper than the first grooves, and a thickness of a conductive material of the input wiring is greater than a thickness of the individual electrodes.

According to this aspect of the invention, since the conductivity of the input wiring is improved to reduce the electrical resistance thereof by increasing the cross-sectional area without enlarging the planar line width of the input wiring, in the droplet ejection head with increased number of nozzles for driving a number of nozzles simultaneously, the time constant of the drive circuit of the electrostatic actuator is reduced, thus the delay in the droplet ejection operation can be reduced. Therefore, the droplet ejection head small in size, superior in response can be realized.

It should be noted that by arranging the top face of the individual electrode and the top face of the conductive material of the input wiring in substantially the same surfaces, the driver IC can easily be mounted, and further, the electrical connection can easily be established. Further, warping and floating of the mounted IC can also be prevented.

The input wiring is preferably made of a metal material. This is because the metal materials have smaller resistivity compared to other materials, and therefore, the time constant of the drive circuit of the electrostatic actuator can be reduced, thus the delay in the droplet ejection operation can be reduced.

It is preferable that the input wiring be mainly composed of a first conductive material having contact with a bottom surface of the second groove, and a second conductive material formed on the first conductive material having a larger thickness than the first conductive material, and a line width of the first conductive material be larger than a line width of the second conductive material. According to this configuration, it becomes possible to use metal having better adhesiveness with the electrode substrate as the first conductive material, and to use metal with smaller electrical resistance as the second conductive material, thus the fixation of the input wiring to the electrode substrate and the reduction of the electrical resistance can be achieved at the same time.

It is preferable that the electrode substrate be made of glass, and

the first conductive material be made of one of chromium and titanium. Since chromium and titanium have good adhesiveness with glass or other metal materials, the fixation force can further be improved.

Further, it is preferable that the second conductive material be made of one of chromium, titanium, gold, silver, copper, aluminum, and a laminate of at least two of chromium, titanium, gold, silver, copper, aluminum. Since these metal materials have low resistivity, the time constant of the drive circuit for the actuators can be reduced.

Further, the individual electrode is preferably made of ITO. Since ITO is transparent, there are advantages that the contact state of the electrode can easily be confirmed and that superior durability can be obtained.

Further, it is preferable that a reservoir substrate be further disposed between the nozzle substrate and the cavity substrate, and provided with a common liquid chamber for reserving a liquid and supplying the ejection cavity with the liquid, a through hole for transporting the liquid from the common liquid chamber to the ejection cavity, and a nozzle communicating hole for transporting the liquid from the ejection cavity to the nozzle hole. According to this configuration, since the capacity of the common liquid chamber can be increased, the influence of the back pressure of the liquid after droplet ejection to other nozzles can surely be prevented.

Further, according to another aspect of the invention, there is provided a droplet ejection device equipped with the droplet ejection head described above.

Further, according to another aspect of the invention, there is provided a method of manufacturing an electrode substrate, including steps of (a) etching a groove for depositing input wiring with an incomplete depth applying an etching mask to a glass substrate, (b) etching a groove for forming an individual electrode and the groove for forming the input wiring with a complete depth applying the etching mask to the glass substrate, (c) depositing the input wiring made of a metal material in the groove for forming the input wiring, and (d) depositing the individual electrode made of ITO in the groove for forming the individual electrode.

Thus, the conductivity of the input wiring can be improved without increasing the size of the electrode substrate. Therefore, in the droplet ejection head with increased number of nozzles for driving a plurality of nozzles and the same time, a droplet ejection head having a reduced time constant of the drive circuit for the electrostatic actuator, thus reducing the delay in the droplet ejection operation can be obtained.

### BRIEF DESCRIPTION OF THE DRAWINGS

The invention will now be described with reference to the accompanying drawings, wherein like numbers refer to like elements.

FIG. 1 is an exploded perspective view of a droplet ejection head according to a first embodiment of the invention.

FIG. 2 is a cross-sectional view of FIG. 1 along the X-X line therein.

FIG. 3 is a vertical cross-sectional view of the droplet ejection head shown in FIG. 1 in an assembled condition.

FIG. 4 is a schematic diagram showing an equivalent circuit of the drive circuit for the actuators for droplet ejection.

FIG. 5 is a correlation diagram showing a relationship in a multi-nozzle inkjet head among the number of nozzles to be driven simultaneously, the time constant of the drive circuit of the actuators, and the material of the input wiring.

FIG. 6 is a schematic block diagram showing a control system of a droplet ejection device equipped with the droplet ejection head shown in FIG. 1.

FIG. 7 is a schematic block diagram showing an example of inside configuration of a driver IC and a COM generating circuit.

FIG. 8A is an exploded schematic diagram of a droplet ejection head according to a second embodiment of the invention, and FIG. 8B is an assembled schematic diagram thereof.

FIG. 9 is a vertical cross-sectional view of a droplet ejection head according to a third embodiment of the invention in an assembled state.

FIG. 10 is a vertical cross-sectional view of a droplet ejection head according to a fourth embodiment of the invention in an assembled state.

FIG. 11 is process chart showing an example of a manufacturing method of an electrode substrate.

FIG. 12 is a perspective view showing an example of a droplet ejection device according to a sixth embodiment, equipped with a droplet ejection head of the invention.

### DESCRIPTION OF THE EMBODIMENTS

### First Embodiment

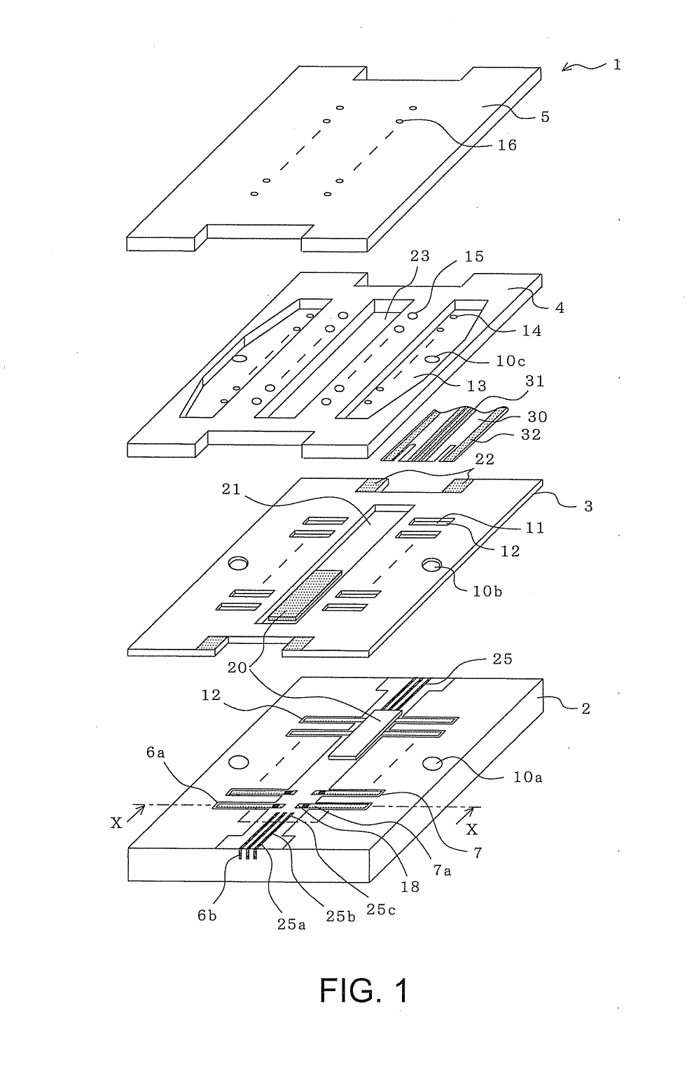

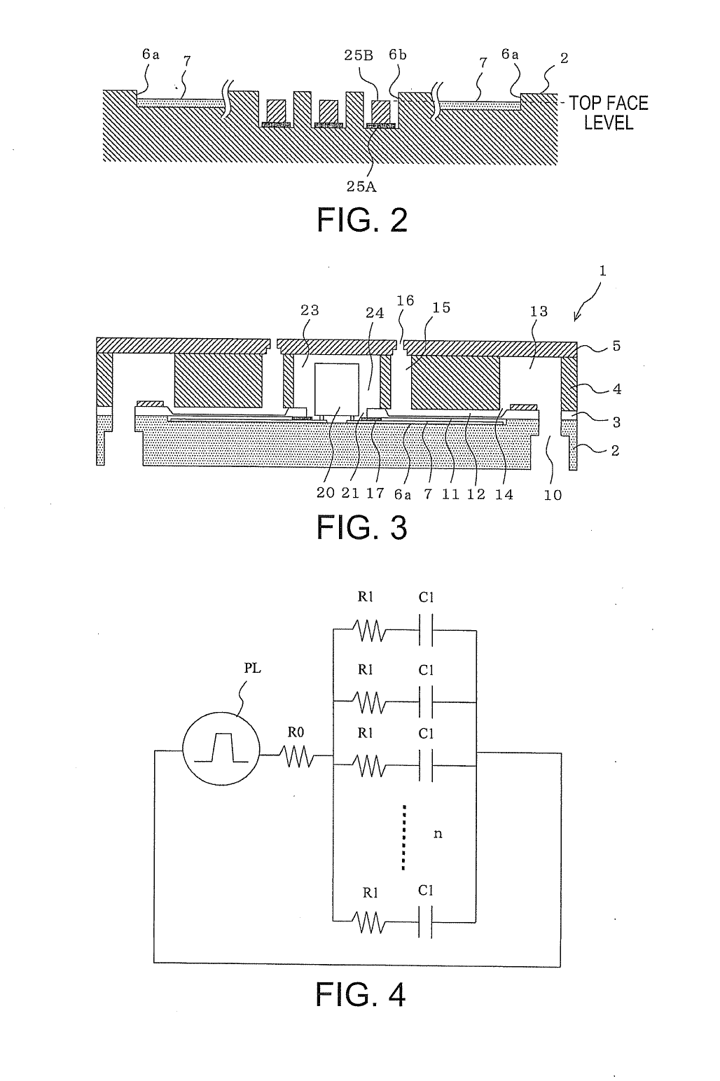

FIG. 1 is an exploded perspective view of a droplet ejection head according to a first embodiment of the invention, and shows a part of a terminal section (hereinafter referred to as FPC 30) of a flexible printed circuit (FPC), which supplies the droplet ejection head with a drive signal, included therein. Further, FIG. 2 is a cross-sectional view thereof along the X-X direction shown in FIG. 1 with a dashed line, FIG. 3 shows a cross-sectional view of the droplet ejection head in an assembled condition along the longitudinal direction of individual electrodes. Hereinafter, a structure and an operation of the droplet ejection head according to the first embodiment will be explained with reference to FIGS. 1 through 3.

As shown in FIG. 1, the droplet ejection head 1 according to the present first embodiment is composed of four substrates, namely an electrode substrate, a cavity substrate, a reservoir substrate 4, and a nozzle substrate 5. On one surface of the reservoir substrate 4, there is bonded the nozzle substrate 5, and on the other surface of the reservoir substrate 4, there is bonded the cavity substrate 3. Further, on the opposite surface of the cavity substrate 3 to the surface to which the reservoir substrate 4 is bonded, there is bonded the electrode substrate 2. In other words, in the droplet ejection head 1, there are bonded the electrode substrate 2, the cavity substrate 3, the reservoir substrate 4, and the nozzle substrate 5 in this order.

The electrode substrate 2 is formed of a glass plate with a thickness of, for example, 1 mm made of borosilicate glass, for example. It should be noted that the electrode substrate 2 can also be made of single crystal silicon.

The electrode substrate 2 is provided with first grooves 6a formed to have a depth of, for example, 0.2 μm. Inside each of the first grooves 6a, there is formed an individual electrode 7 so as to face a diaphragm 11 described later with a predetermined distance by sputtering, for example, indium tin oxide (ITO) thereon with a thickness of about 0.1 μm. It should be noted that in this case, a gap between the individual electrodes 7 and the diaphragms 11 after bonding the electrode substrate 2 and the cavity substrate 3 becomes about 0.1 μm.

In an intermediate area between the first grooves 6a on the right side and the first grooves 6a on the left side, there are provided patterns so as to allow a driver IC 20 to be mounted on the electrode substrate 2, and the driver IC 20 is mounted on this area. Input terminals of the driver IC 20 are connected to the input wiring 25 (including FPC mounting sections 25a, lead sections 25b, and driver IC input terminal mounting sections 25c), and output terminals of the driver IC 20 are connected to the end sections of the individual electrodes 7. It should be noted that from the viewpoint of reduction of the circuit resistance, it is desirable that the input terminals of the driver IC 20 are directly connected to the input wiring 25, and the output terminals thereof are directly connected to end sections of the individual electrodes 7.

The input wiring 25 is wiring for introducing the driving power or signals for driving the plurality of individual electrodes 7 from the outside of the electrode substrate 2. The input wiring 25 is formed inside second grooves 6b provided to the electrode substrate 2 using metal material to have a thickness in a range of, for example, about 0.1 through 0.3 μm. Therefore, the depth of the second grooves 6b is, for example, about 4 μm.

Further, here as shown in FIG. 2, it is arranged that the top face levels of the individual electrodes 7 and the input wiring 25 are substantially the same so that the top faces thereof are included in substantially the same planes, thus mounting and connection of the driver IC 20 can be performed easily, and electrically stable connection can be obtained after mounting the driver IC 20.

Further, here as shown in FIG. 2, the input wiring 25 is composed of a first conductive member 25A having contact with the bottom face of the second groove 6b and a second conductive member 25B formed on the first conductive member 25A to have a larger thickness than the that of the first conductive member 25A, wherein the first conductive member 25A has a larger line width than that of the second conductive member 25B. In this case, it is preferable that the first conductive member 25A is made of metal, such as chromium or titanium, having good adhesiveness with the electrode substrate 2 and the second conductive member 25B, and the second conductive member 25B is made of chromium, titanium, gold, silver, copper, aluminum, or a laminated combination of any of these materials having good adhesiveness with the first conductive member 25A, good electrical conductivity, and small electrical resistance.

The driving power or the signal introduced from the input wiring 25 is controlled by the driver IC 20, and is supplied from the driver IC 20 to a predetermined individual electrode 7 as a pulse voltage. In other words, the input power or the input signal from the outside of the electrode substrate 2 to the driver IC 20 is input along the following course: the FPC 30→the FPC mounting section 25a of the input wiring 25→the lead section 25b of the input wiring 25→the driver IC input terminal mounting section 25c of the input wiring 25→the driver IC 20. Further, an output signal is output from the driver IC 20 to each of the individual electrodes 7 corresponding respectively to the nozzles 16 along following course: the driver IC output terminal mounting section of the individual electrode 7→the lead section 7a of the individual electrode 7→a part of the individual electrode 7 opposed to the diaphragm 11. Thus, the electrostatic actuator for droplet ejection formed of the individual electrode 7, the diaphragm 11, and so on is driven.

The individual electrodes 7 are each formed to have a rectangular shape with long sides and short sides, and are arranged in parallel so that the long sides are parallel to each other to form electrode lines extending in the direction of the short sides of the individual electrodes 7.

Further, the driver IC 20 is formed between the right line and the left line of the individual electrodes 7, and is connected to each of the individual electrodes 7. Thus, it becomes possible to supply the two electrode lines, namely the right line and the left line of the electrodes with drive signals, which makes it easy to increase the number of electrode lines. Further, since the number of the driver IC 20 can also be reduced, cost reduction becomes possible, and downsizing of the droplet ejection head 1 also becomes possible. It should be noted that the electrode substrate 2 is provided with liquid supply holes 10a communicated with the reservoir (corresponding to common liquid chambers 13 of the reservoir substrate 4) for pooling an ejection liquid, and the liquid supply holes 10a penetrate the electrode substrate 2.

The cavity substrate 3 is made, for example, of single crystal silicon, and provided with ejection cavities 12 each having the diaphragm 11 as the bottom wall thereof. It should be noted that there are formed a plurality of ejection cavities 12 in two lines corresponding to the individual electrodes 7. Further, the cavity substrate 3 is provided with a first hole section 21 formed in an intermediate area between the right line and the left line of the ejection cavities 12 so as to penetrate the cavity substrate 3, and is further provided with common electrodes 22 for applying a voltage to each of the diaphragms 11. The common electrodes 22 are connected to the FPC 30.

In the present embodiment, the cavity substrate 3 is made of single crystal silicon, covered with an insulating film (not shown) with a thickness of about 0.1 μm made of tetraethyl orthosilicate (TEOS) formed by plasma chemical vapor deposition (CVD) on the entire surface thereof. This film is formed for preventing dielectric breakdown and short circuit in driving the diaphragm 11, and for preventing etching of the cavity substrate 3 by a liquid such as ink. Further, the cavity substrate 3 is provided with liquid supply holes 10b communicated respectively with the common liquid chambers 13.

The diaphragm 11 is preferably formed of a high-concentration boron-doped layer. This is because by forming areas of a silicon substrate to be the diaphragms as the high-concentration boron-doped layers, a so-called etch stop technology, that when the ejection cavities 12 are formed by anisotropic etching with an alkaline solution, the boron-doped layer is exposed to dramatically reduce the etching rate, can be used, thus the diaphragm 11 can be formed to have a desired thickness.

By bonding the electrode substrate 2 and the cavity substrate 3 to each other, a gap to be a vibration area of the diaphragm 11 is formed between the individual electrode 7 and the diaphragm 11. The gap is an important space for causing the electrostatic force, and is coated with a sealing material 17 in the end section of the opening of the space so that no foreign matters enter inside thereof (see FIG. 3).

The reservoir substrate 4 is made, for example, of single crystal silicon, and provided with two common liquid chambers 13 as liquid reservoirs for supplying the ejection cavities 12 with the ejection liquid on the right side and the left side thereof. The bottom face of each of the common liquid chambers 13 is provided with through holes 14 for transporting the liquid from the common chambers 13 to the ejection cavities 12 and liquid supply holes 10c penetrating the bottom face. Further, the reservoir substrate 4 is provided with nozzle communicating holes 15 respectively communicated with the ejection cavities 12 and for transporting the liquid from the ejection cavities 12 to respective nozzle holes 16 described later. Further, between the right side and the left side common liquid chambers 13 of the reservoir substrate 4, there is formed a second hole 23 penetrating the reservoir substrate 4.

As shown in FIG. 3, the liquid supply hole 10c provided to the reservoir substrate 4, the liquid supply hole 10b provided to the cavity substrate 3, and the liquid supply hole 10a provided to the electrode substrate 2 are connected to each other to form the liquid supply hole 10 for supplying the liquid from the outside to the common liquid chambers 13 in the condition in which the reservoir substrate 4, the cavity substrate 3, and the electrode substrate 2 are bonded to each other.

Further, the first hole section 21 provided to the cavity substrate 3 and the second hole section 23 provided to the reservoir substrate 4 are communicated with each other to form a housing section 24 for the driver IC 20.

The nozzle substrate 5 is formed of a silicon substrate with a thickness, for example, of 100 μm, and is provided with a plurality of nozzle holes 16 communicated with the respective nozzle communicating holes 15. In the present first embodiment, the nozzle holes 16 are formed to have a two-tiered shape, thus improving straightness in ejecting the droplets.

The electrode substrate 2, the cavity substrate 3, the reservoir substrate 4, and the nozzle substrate 5 can be bonded each other by, for example, anodic bonding in the case of bonding a substrate made of silicon and a substrate made of borosilicate glass, or an adhesive in the case of bonding silicon substrates.

The droplet ejection head 1 of the present embodiment has the driver IC housed inside the housing section 24, and the housing section 24 is enclosed with the nozzle substrate 5, the cavity substrate 3, the reservoir substrate 4, and the electrode substrate 2. Specifically, it is arranged that the nozzle substrate 5 forms the upper surface of the housing section 24, the electrode substrate 2 forms the lower surface of the housing section 24, and the cavity substrate 3 and the reservoir substrate 4 form the side surfaces of the housing section 24, thereby enclosing the housing section 24.

FIG. 4 is a schematic diagram showing an equivalent circuit of the drive circuit including the actuators composed of the individual electrodes 7 and the diaphragms 11. The reference characters in FIG. 4 denote as follows.

PL (drive power or a drive signal)

It denotes a drive pulse of the driver IC 20.

RO (resistance of a common section of the circuit)

It denotes the equivalent resistance of the resistance along the following path: the FPC mounting section 25a of the input wiring 25→the lead section 25b of the input wiring 25→the driver IC input terminal mounting section 25c of the input wiring 25. On this occasion, the resistance of the lead section 25b of the input wiring 25 provides the most significant influence.

R1 (resistance of an individual section of the circuit)

It denotes the equivalent resistance of the internal resistance of the driver IC 20 and resistance along the following path: the output terminal mounting section of the individual electrode 7→the lead section 7a of the individual electrode 7→a part of the individual electrode 7 opposed to the diaphragm 11.

C1 (capacitance of the actuator)

It denotes the capacitance of the actuator (electrostatic actuator) composed of the individual electrode 7 and the diaphragm 11.

n (the number of driven actuators)

It denotes the number of driven nozzles.

Under the above conditions, the time constant τ of the circuit shown in FIG. 4 can be represented as a function of the number n of the driven nozzles as described below.

τ=(C1×n)×(R0+R1/n)

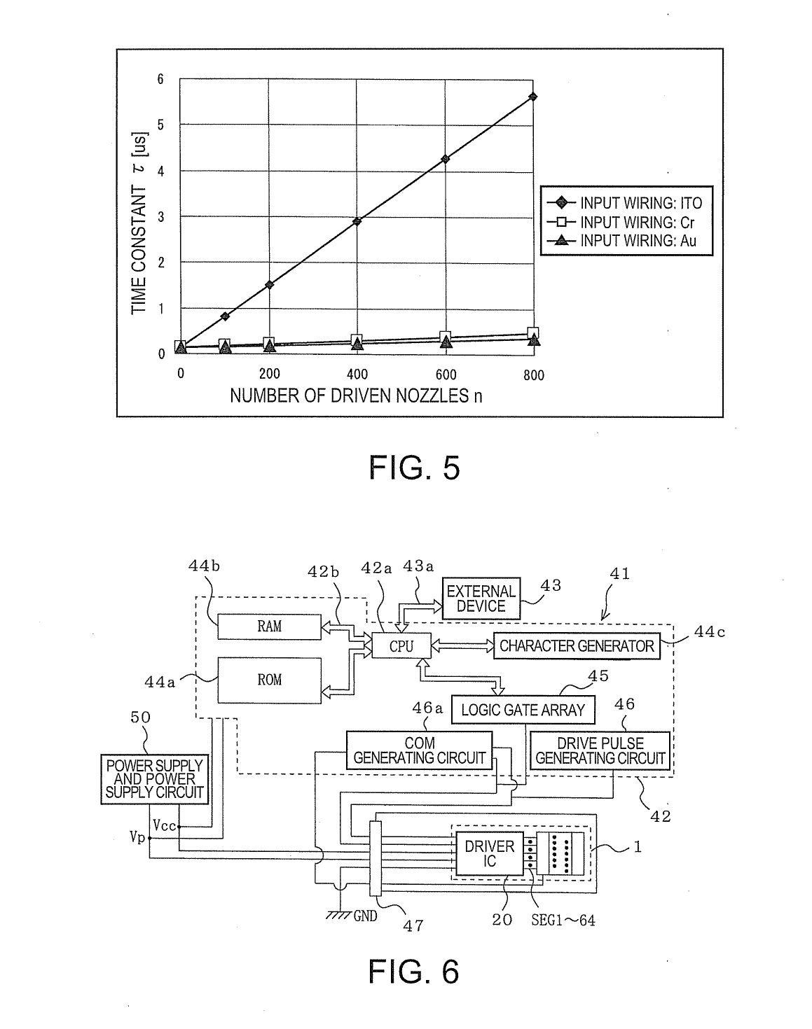

FIG. 5 is a correlation diagram showing a relationship in a multi-nozzle inkjet head among the number n of nozzles to be driven simultaneously, the time constant τ of the drive circuit of the actuators, and the material of the input wiring 25. As shown in FIG. 5, as the number n of the nozzles to be driven simultaneously increases, the time constant τ of the actuator drive circuit increases. In contrast to the fact that this tendency is particularly remarkable in the case in which the input wiring 25 is made of ITO, increase in the time constant τ is significantly small in the case in which the input wiring 25 is made of chromium (Cr) or gold (Au). Therefore, it proves that by forming the input wiring 25 from the metal material such as chromium or gold, the increase in time constant τ of the actuator drive circuit can be suppressed to a small value even when the number n of nozzles driven simultaneously is increased in the multi-nozzle head, thus the operation delay in the droplet ejection can be prevented to improve the response.

Taking the manufacturing process into consideration, the input wiring 25 can more easily be formed by forming from ITO at the same time as formation of the individual electrodes 7 made of ITO. However, since ITO has large resistivity, when a number of nozzles are driven simultaneously, the time constant of the corresponding actuators increases as shown in FIG. 5, to deteriorate the response.

Therefore, the input wiring 25 should be made of a metal material having a smaller resistivity than ITO. The input wiring 25 is preferably formed, for example, from chromium, a laminate of chromium and gold, or a laminate of ITO, chromium, and gold. This is because chromium has a smaller resistivity than ITO, and also has a good adhesiveness with the electrode substrate made of glass. Further, since gold has a smaller resistivity than chromium, even in the case in which the input wiring is formed from the laminate of chromium and gold or the laminate of ITO, chromium, and gold, the resistivity of the input wiring can be reduced as a whole. Further, also by forming the input wiring 25 from a laminate of titanium and gold, silver, copper, aluminum, or the like, the resistivity of the wiring as a whole can be reduced compared to the case with ITO. Therefore, by forming the input wiring 25 from such metal materials, even when driving a number of drivers simultaneously, the delay in the operational response can be reduced to improve the response.

The operation of the droplet ejection head 1 will now be explained. The common liquid chambers 13 are supplied with a liquid such as ink from the outside via the liquid supply hole 10. Further, the ejection cavities 12 are supplied with the liquid from the common liquid chambers 13 via the respective through holes 14. The driver IC 20 is supplied with the drive signals from the control section (not shown) of the droplet ejection device via IC wiring 31 in the FPC 30 and the input wiring 25 (25a, 25b, 25c) provided to the electrode substrate 2. When ejecting the droplet from the nozzle hole 16, the driver IC 20 applies a pulse voltage in a range of about 0V through 40V to the individual electrode 7 to charge the individual electrode 7 positively, for example, while charging the opposed diaphragm 11 negatively by supplying the drive signal thereto from the control section (not shown) of the droplet ejection device via common electrode wiring 32. On this occasion, the diaphragm 11 is pulled by the electrostatic force towards the individual electrode 7 to be distorted accordingly. Then, when the pulse voltage described above is released, the electrostatic force acting on the diaphragm disappears, thus the diaphragm 11 is restored. At this moment, the inside pressure of the ejection cavity 12 rises rapidly, and the liquid inside the ejection cavity 12 should be ejected as a droplet from the nozzle hole 16 after passing through the nozzle communicating hole 15. After then, the liquid is supplied inside the ejection cavity 12 from the common liquid chamber 13 via the through hole 14, thus the initial condition is restored.

Supply of the liquid to the common liquid chambers 13 of the droplet ejection head 1 is performed through, for example, a liquid supply tube (not shown) connected to the liquid supply holes 10. Further, in the present embodiment, the FPC 30 is connected to the driver IC 20 so as to be parallel to the direction of the short sides of the individual electrodes 7. However, in the case in which the short sides of the individual electrodes are not perpendicular to the long sides thereof to form the individual electrodes 7 each having an elongated parallelogram shape, the FPC 30 is preferably connected in a direction perpendicular to the long sides of the individual electrodes 7. Thus, the droplet ejection head 1 having a plurality of electrode lines and the FPC 30 can be connected to each other in a compact manner.

FIG. 6 is a schematic block diagram showing the control system of the droplet ejection device having the droplet ejection head 1 mounted thereon. The droplet ejection device is assumed to be a typical inkjet printer. It should be noted that the control system of the droplet ejection device on which the droplet ejection head 1 is mounted is not limited to what is shown in FIG. 6.

The droplet ejection device on which the droplet ejection head 1 is mounted has a droplet ejection head drive control device 41 for controlling drive of the droplet ejection head 1, and the droplet ejection head drive control device 41 is provided with a control section (a section surrounded by the broken lines) 42 composed mainly of a CPU 42a. The CPU 42a is supplied with print information from an external device 43 such as a personal computer via a bus 43a, and further, a ROM 44a, a RAM 44b, and a character generator 44c are connected thereto via an internal bus 42b.

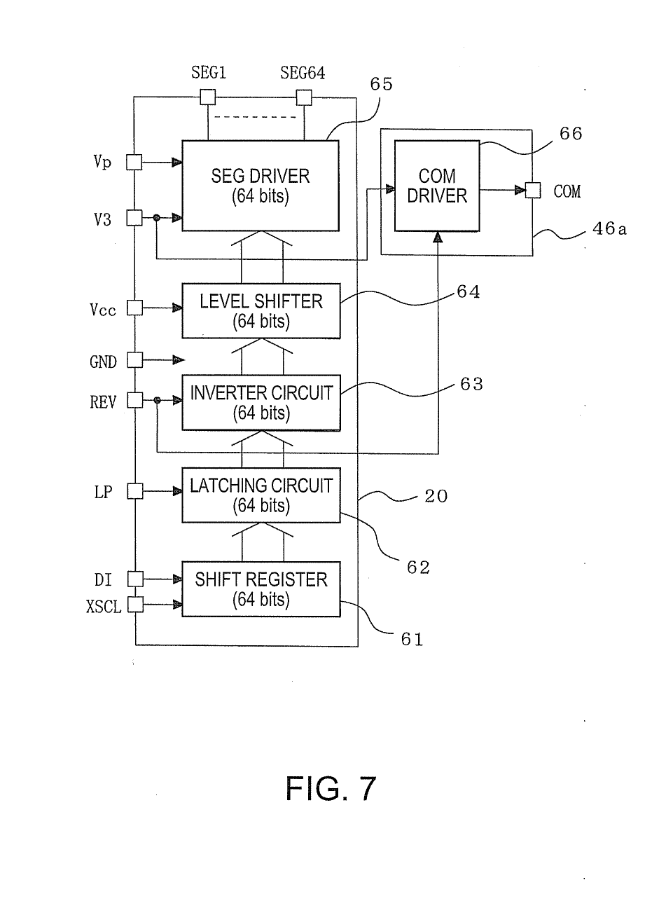

The control section 42, using a storage area in the RAM 44b as a working space, executes a control program stored in the ROM 44a to generate the control signals for driving the droplet ejection head 1 based on the character information generated by the character generator 44c. The control signals are modified by a logic gate array 45 and a drive pulse generating circuit 46 to drive control signals corresponding to the print information, and supplied to the driver IC 20 built-in in the droplet ejection head and also to a COM generating circuit 46a. Further, the driver IC 20 is also supplied with a drive pulse signal V3, a control signal LP, a polarization reverse control signal REV, and so on used for printing (see FIG. 7). It should be noted that the COM generating circuit 46a is composed mainly of a common electrode IC (not shown) for generating a drive pulse, for example.

The COM generating circuit 46a outputs the drive signal (a drive voltage pulse) to be applied to the common electrode 22, namely each of the diaphragms 11 of the droplet ejection head 1 from a common output terminal COM (not shown) based on the supplied signals described above. Further, the driver IC 20 outputs the drive signals (drive voltage pulses) to be applied to the respective individual electrodes 7 from a corresponding number of individual output terminals SEG to the number of individual electrodes 7 based on the supplied signals described above and the drive voltage Vp supplied from a power supply circuit 50. The potential differences between the output of the common output terminal COM and the output of the individual output terminals SEG are applied between the each of the diaphragms 11 and the respective individual electrodes 7 opposed thereto. It is arranged that a drive voltage waveform in the designated direction is applied when driving (ejecting a droplet) the diaphragm 11 while the drive voltage is not applied when not driving the diaphragm.

FIG. 7 is a schematic block diagram showing an example of an inside configuration of the driver IC 20 and the COM generating circuit 46a. It should be noted that a set of the driver IC 20 and the COM generating circuit 46a is assumed to supply 64 individual electrodes 7 and the corresponding diaphragms 11 with the drive signals.

The driver IC 20 is a high withstand voltage CMOS drive with 64-bit output, operable with the high-voltage drive voltage Vp and the logic circuit drive voltage Vcc supplied from the power supply circuit 50. The driver IC 20 applies either one of the drive voltage pulse and the GND potential to the individual electrode 7.

The driver IC 20 has a 64 bit shift register 61, the shift register 61 is formed as a static shift register for shifting-up the DI signal input of 64 bit length, which is transmitted from the logic gate array 45 as serial data, by an XSCL pulse signal input as a primary clock pulse in sync with the DI signal, and storing it in a register in the shift register 61. The DI signal is a control signal representing the selection information for selecting each of the 64 individual electrodes 7 by on/off, and is transmitted as the serial data.

Further, the driver IC 20 has a 64 bit latching circuit 62, and the latching circuit 62 is a static latch for latching the 64 bit data stored in the shift register 61 by the control signal (latching pulse) LP to store the data, and for outputting the data to the 64 bit inverter circuit 63. The latching circuit 62 converts the DI signal as the serial data into a 64 bit parallel signal for performing 64 segments of outputs for driving respective diaphragms 11. The inverter circuit 63 outputs the exclusive OR of the signal input from the latching circuit and the REV signal to the level shifter 64. The level shifter 64 is a level interface circuit for converting the voltage level of the signal from the inverter circuit 63 from the logic voltage level (5V level or 3.3V level) into head driving voltage level (0 through 45V level).

An SEG driver 65 has 64 channels of transmission gate outputs, and outputs either one of the drive voltage pulse input and the GND to each of the segment outputs SEG1 through SEG64 in accordance with the input of the level shifter 64. A COM driver 66 built-in in the COM generating circuit 46a outputs either one of the drive voltage pulse and the GND to the COM terminal in accordance with the REV input.

The signals of XSCL, DI, LP, and REV are each a signal in the logic voltage level, and are transmitted from the logic gate array 45 to the driver 20. By configuring the driver IC 20 and the COM generating circuit 46a as described above, even in the case in which the number of segments (the number of diaphragms 11) to be driven is increased, the drive voltage pulse for driving the diaphragm 11 of the droplet ejection head 1 and the GND can easily be switched.

In the droplet ejection head 1 of the present first embodiment configured as described above, since the cavity substrate 3 is provided with the first hole section 21, the reservoir substrate 4 is provided with the second hole section 23, the first and the second hole sections 21, 23 forming the housing section 24, and the driver IC 20 is housed in the housing section 24, the size of the droplet ejection head 1 can be reduced.

Further, since the individual electrodes 7 are aligned in parallel to form a plurality of electrode lines, and the driver IC 20 is connected to the two electrode lines, it becomes possible to supply the right and the left electrode lines with the drive signals from the driver IC 20, thus increase in the number of electrode lines becomes easy. Further, since the number of the driver IC 20 can also be reduced, cost reduction becomes possible, and downsizing of the droplet ejection head also becomes possible.

In addition, since the input wiring 25 to the driver IC 20 is made of a metal material, and the thickness thereof is larger than in the related art, reduction of resistance of the input wiring, which is common to all of the nozzles, becomes possible, and even in the case in which the number of nozzles to be driven simultaneously is large, the time constant of the drive circuit of the actuator composed mainly of the individual electrode 7 and the diaphragm 11 can be reduced. Thus, the delay in the operation can be reduced to obtain the droplet ejection head with ejection performance superior in response. It should be noted that by configuring it to have the time constant of the circuit described above a fourth of the rising time of the drive pulse, for example, the operational delay of the actuator is not recognized even when a number of nozzles are driven simultaneously, the stable print quality can be obtained.

### Second Embodiment

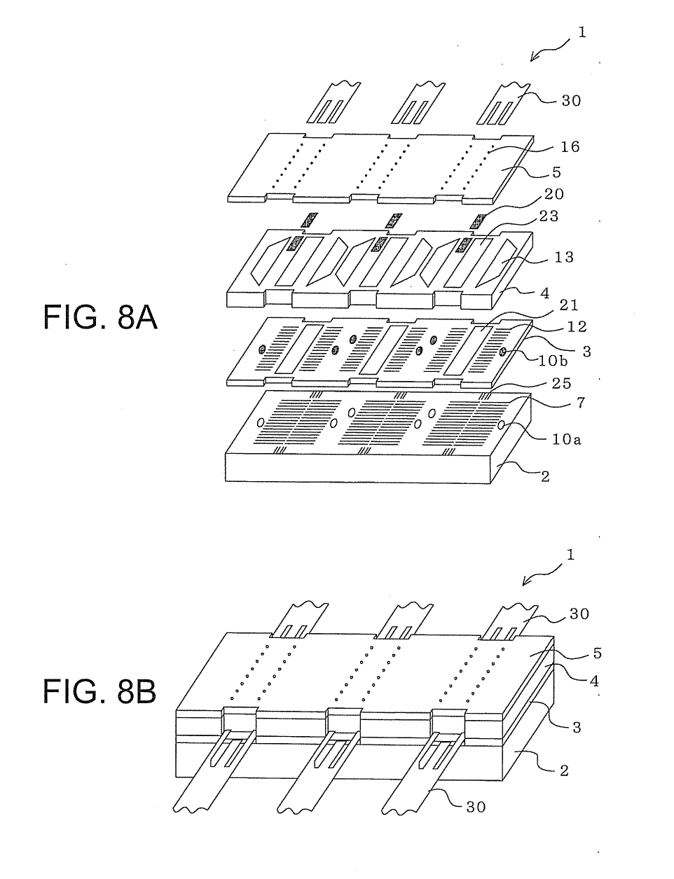

FIG. 8A is an exploded schematic diagram of a droplet ejection head according to a second embodiment of the invention, and FIG. 8B is an assembled schematic diagram thereof. The droplet ejection head 1 according to the second embodiment of the invention has six electrode lines formed of the individual electrodes 7 and so on, and the ejection cavities 12 are also formed in six lines accordingly. Further, two driver IC 20 are provided for every two electrode lines so that the driver IC 20 supplies the drive signals to electrode lines formed on both sides of the driver IC 20.

Other structures and operations are the same as those of the droplet ejection head 1 of the first embodiment shown in FIG. 1, and the explanations therefor will be omitted. It should be noted that the same components as those of the droplet ejection head 1 according to the first embodiment are denoted with the same reference numerals.

Since six electrode lines are formed in the present second embodiment, by arranging that the colors of the ink ejected from the different electrode lines (corresponding to the lines of the ejection cavities) are different from each other, multicolor printing can easily be realized. Other advantages thereof are the same as those of the droplet ejection head 1 according to the first embodiment.

### Third Embodiment

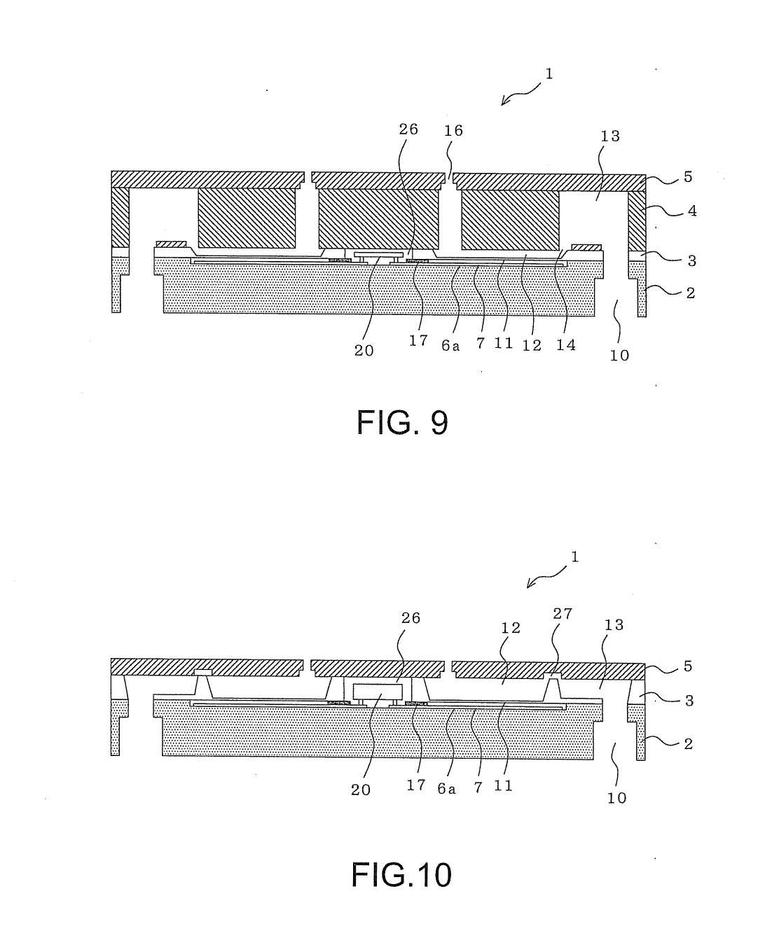

FIG. 9 is a vertical cross-sectional view of a droplet ejection head according to a third embodiment of the invention in an assembled state. In the droplet ejection head 1 according to the third embodiment, the reservoir substrate 4 is not provided with the second hole section 23, but the cavity substrate 3 is provided with a hole section 26 corresponding to the first hole section 21, and the driver IC 20 is housed inside the hole section 26. It is arranged that the reservoir substrate 4 forms the upper surface of the hole section 26, the electrode substrate 2 forms the lower surface of the hole section 26, and the cavity substrate 3 forms the side surfaces of the hole section 26, thereby the hole section 26 is enclosed.

Other structures and operations are the same as in the droplet ejection head 1 of the first embodiment, and the advantages thereof are substantially the same as in the droplet ejection head 1 according to the first embodiment.

### Fourth Embodiment

FIG. 10 is a vertical cross-sectional view of a droplet ejection head according to a fourth embodiment of the invention in an assembled state. The droplet ejection head 1 according to the fourth embodiment is not provided with the reservoir substrate 4, and is composed of three substrates, namely the electrode substrate 2, the cavity substrate 3, and the nozzle substrate 5. Here, the common liquid chambers 13 are formed in the cavity substrate 3, and the common liquid chambers 13 and the ejection cavities are communicated with each other by orifices 27 provided to the nozzle substrate 5 instead of the through holes 14. It should be noted that the orifices 27 can also be provided to the cavity substrate 3. The droplet ejection head 1 according to the fourth embodiment has two electrode lines formed of the individual electrodes 7, and the cavity substrate 3 is provided with the hole section 26 similarly to the droplet ejection head 1 according to the third embodiment, inside of which the driver IC 20 is housed. It should be noted that three or more electrode lines of the individual electrodes 7 can be provided similarly to the droplet ejection head according to the second embodiment. Further, it is arranged that the nozzle substrate 5 forms the upper surface of the hole section 26, the electrode substrate 2 forms the lower surface of the hole section 26, and the cavity substrate 3 forms the side surfaces of the hole section 26, thereby the hole section 26 is enclosed.

Other structures and operations are the same as those of the droplet ejection head 1 explained in the first embodiment, and the explanations therefor will be omitted. In this structure, although there is a disadvantage of the smaller common liquid chambers in comparison with the first through the third embodiments, there is an advantage that the droplet ejection head 1 can be formed smaller since the reservoir substrate 4 is eliminated.

### Fifth Embodiment

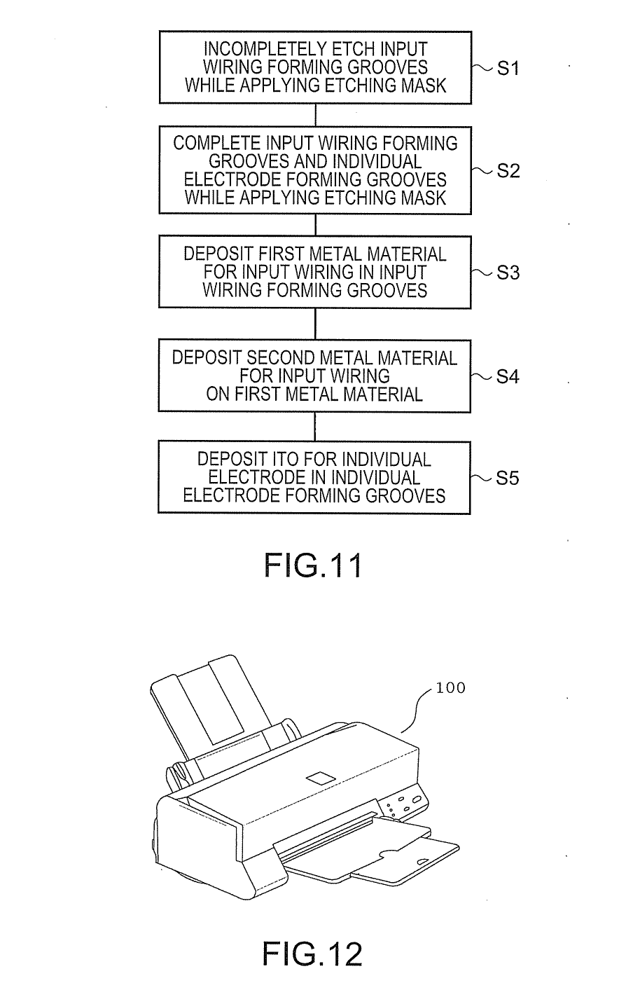

Here, a method of manufacturing the electrode substrate used for the droplet ejection head 1 explained in the first through fourth embodiments will briefly be explained. FIG. 11 is a process chart showing an example of a method of manufacturing the electrode substrate 2, along which the explanations will be presented below.

Firstly, an etching mask is applied to a glass substrate to be the electrode substrate 2, and etching is performed so that the input wiring forming grooves (the second grooves 6b which have been explained hereinabove) have an incomplete depth (e.g., 0.2 μm) (a first etching step S1).

Subsequently, the etching mask is applied to the glass substrate, and the etching is further performed until the input wiring forming grooves (the second grooves 6b which have been explained hereinabove) and the individual electrode forming grooves (the first grooves 6a which have been explained hereinabove) reach the complete depth (e.g., the first grooves 6a reach 0.2 μm, the second grooves 6b reach 0.4 μm) (a second etching step S2). It should be noted that as the etching in the steps S1, S2, a wet etching process can be used, for example.

Subsequently, a first metal material (e.g., chromium or titanium) is deposited in the second grooves 6b for forming the input wiring 25 with a thickness in a range of about 5 through 30 nm (a step S3 of forming the first conductive material 25A of the input wiring). Subsequently, the second metal material (e.g., chromium, titanium, gold, silver, copper, or aluminum) is deposited on the first metal material with a thickness in a range of about 100 through 300 nm (a step S4 of forming the second conductive material 25B of the input wiring).

Further, ITO is deposited in the first grooves 6a for forming the individual electrodes 7 with a thickness of about 0.1 μm by sputtering (an individual electrode forming step S5).

It should be noted that when depositing the individual electrodes 7 and the input wiring 25, the top face of the individual electrodes 7 and the top face of the second conductive material 25B of the input wiring are arranged to be in substantially the same planes (the same level).

Finally, the liquid supply holes 10a are formed through the glass substrate, thereby completing the electrode substrate 2.

According to the manufacturing method of the electrode substrate described above, since the conductivity of the input wiring can be improved without increasing the size of the electrode substrate 2 to reduce the electrical resistance, even in the droplet ejection head with increased number of nozzles for driving a plurality of nozzles simultaneously, the droplet ejection head reducing the time constant of the drive circuit for the electrostatic actuators to reduce the delay in the droplet ejection operation can be obtained.

### Sixth Embodiment

FIG. 12 is a perspective view of an inkjet printer 100 showing an example of a droplet ejection device on which the droplet ejection head shown in the embodiment described above as the droplet ejection section thereof. Since the droplet ejection head of the embodiments of the invention has the advantages of small in size and superior in durability, and also superior in response even when a number of nozzles are driven simultaneously, the same advantages can also be obtained with the droplet ejection device on which the droplet ejection head described above is mounted.

It should be noted that the droplet ejection head, which has been explained in each of the embodiments, can be applied to various applications such as a manufacturing apparatus of a color filter of a liquid crystal display device, an apparatus for forming a light emitting section of an organic EL display device, or an apparatus for ejecting a biological fluid by variously changing the types of liquid to be ejected as droplets, besides the application as a printer shown in FIG. 12.

What is claimed is:

1. A droplet ejection head, comprising:
a nozzle substrate provided with a plurality of nozzle holes for ejecting a droplet;
a cavity substrate provided with a plurality of ejection cavities each having a diaphragm as a bottom wall functioning as an electrode; and
an electrode substrate including a plurality of individual electrodes each formed in a first groove, opposed to the diaphragm with a gap, and for driving the diaphragm; a driver IC for controlling driving of the plurality of individual electrodes; and input wiring formed in a second grooves, and for inputting one of power and a signal for driving the drover IC from the outside,
wherein the second grooves of the electrode substrate are formed deeper than the first grooves, and a thickness of a conductive material of the input wiring is greater than a thickness of the individual electrodes.

2. The droplet ejection head according to claim 1, wherein
a top face of the individual electrodes and a top face of the conductive material of the input wiring are included in substantially the same planes.

3. The droplet ejection head according to claim 1, wherein
the input wiring is made of a metal material.

4. The droplet ejection head according to claim 3, wherein
the input wiring is mainly composed of a first conductive material having contact with a bottom surface of the second groove, and a second conductive material formed on the first conductive material having a larger thickness than the first conductive material, and a line width of the first conductive material is larger than a line width of the second conductive material.

5. The droplet ejection head according to claim 4, wherein
the electrode substrate is made of glass, and
the first conductive material is made of one of chromium and titanium.

6. The droplet ejection head according to claim 4, wherein
the second conductive material is made of one of chromium, titanium, gold, silver, copper, aluminum, and a laminate of at least two of chromium, titanium, gold, silver, copper, aluminum.

7. The droplet ejection head according to claim 1, wherein
the individual electrode is made of ITO.

8. The droplet ejection head according to claim 1, further comprising:
a reservoir substrate disposed between the nozzle substrate and the cavity substrate, and provided with a common liquid chamber for reserving a liquid and supplying the ejection cavity with the liquid, a through hole for transporting the liquid from the common liquid chamber to the ejection cavity, and a nozzle communicating hole for transporting the liquid from the ejection cavity to the nozzle hole.

9. A droplet ejection device comprising the droplet ejection device according to claim 1.

10. A method of manufacturing an electrode substrate, comprising:
(a) etching a groove for forming input wiring with an incomplete depth applying an etching mask to a glass substrate;
(b) etching a groove for forming an individual electrode and the groove for forming the input wiring with a complete depth applying the etching mask to the glass substrate;
(c) depositing the input wiring made of a metal material in the groove for forming the input wiring; and
(d) depositing the individual electrode made of ITO in the groove for forming the individual electrode.
